(19) United States
(12) Patent Application Publication
(10) Pub. No.: US 2007/0035138 A1
(43) Pub. Date: Feb. 15, 2007

(54) Vacuum powered generators

(76) Inventor: Sajid Ali Khan, Ridgefield Park, NJ (US)

Correspondence Address: SAJID ALI KHAN, 2 UNION PLACE, RIDGEFIELD PARK, NJ, 07660, US

(21) Appl. No.: 11/487,806

(22) Filed: Jul. 17, 2006

Related U.S. Application Data
(60) Provisional application No. 60/700,214, filed on Jul. 18, 2005.

(51) Int. Cl. F03B 13/00; H02P 9/04

(52) U.S. Cl. 290/54

(57) ABSTRACT

A horizontal wind tunnel that has an inlet end and an outlet end and a conveying portion there between together with an exhaust means for causing air to move out at the outlet end, thereby creating a vacuum at the outlet end. The vacuum causing atmospheric wind to enter at said inlet end, to fill said vacuum. A plurality of wind driven propellers/turbines being mounted in the tunnel, between the inlet and outlet ends of said tunnel. Electric generators being operatively connected to the wind driven propellers/turbines by a mechanical transmission means and a gearing to convert mechanical energy of the wind driven propellers/turbines into electrical energy.

### CROSS-REFERENCE To RELATED APPLICATIONS

Provisional Application No. 60/700,214 dated Jul. 18, 2005

### FEDERAL SPONSORED PROGRAM

Not Applicable

### SEQUENCE LISTING OR PROGRAM

Not Applicable

### BACKGROUND OF THE INVENTION

1. Field of Invention

This invention relates to vacuum powered electrical generators.

2. Background of the Invention

There are many wind powered generating devices, as there are solar powered generating devices. There are even devices generating electrical power that are using both solar and wind power. There is at least one invention, (Pat. No. 4,779,006) that uses both solar and wind power along with partial vacuum power. However there is no electrical power generating device that uses just the full power of vacuum pressure. According to this applicant vacuum power is the fulcrum of wind power. It is about time that vacuum power was tapped, among others uses, to generate electrical power.

Prior Art exists in relation to this invention. Wartham, Pat. No. 4,779,006 teaches using the power of a partial vacuum to move air to generate electricity. However Wartham's device is massive and cannot be adapted for use in small or even big moving vehicles. Its major portion needs to be buried 1,400 feet underground. Wartham's device is dependent on fickle wind and solar power; it also has a plurality of exhaust portions,

And it requires a water reservoir, a spraying system and a flywheel. Nevertheless, the Wartham device correctly utilizes the power of partial vacuum pressure.

In light of the foregoing a need exists in the prior art for a much simpler and less complicated power generating device that uses vacuum pressure to the maximum and is at the same time small enough to be mounted on cars or large enough for whole cities and of appropriate size for everything in between.

### OBJECTS AND ADVANTAGES

1. It is an object of the present invention to provide a simple power generating device which uses vacuum power to move air to generate electricity.
2. There is not a single wind powered or solar powered or vacuum powered generator that is portable or which can be mounted on cars. This invention can be made as small or as large as needed.
3. This invention is not dependant on fickle wind or solar energy.
4. The present invention is relatively economical to construct and operate.
5. This invention taps unlimited, freely available atmospheric pressure to create wind power.

### SUMMARY

This invention provides a device, which utilizes vacuum power for producing electrical energy, comprising a horizontal wind tunnel that has an inlet which has a one way valve at said inlet, enabling wind to only enter and not exit from said inlet. Further said tunnel has an outlet end which has an outlet end which has a one way valve at said outlet end enabling wind to only exit and not enter from said outlet.

Further containing a horizontal tunnel portion between said inlet end and said outlet end. A blower driven by a battery or outside electric source is placed at the outlet end of said wind tunnel. A plurality of wind driven propeller/turbine are mounted in said tunnel being spaced a selected distance from one another. Electric generators are operatively connected to said wind driven propellers/turbines by a mechanical transmission means and a gearing to convert mechanical energy of said propellers/turbines into electrical energy.

When the blower at the outlet end is switched on, it causes air to exit causing a vacuum at outlet end. Atmospheric air rushes in to fill this vacuum, from the inlet end. Propellers/turbines being placed between the two ends are subjected to wind power which in turn rotates the propellers/turbines thus generating electricity.

### BRIEF DESCRIPTION OF DRAWING

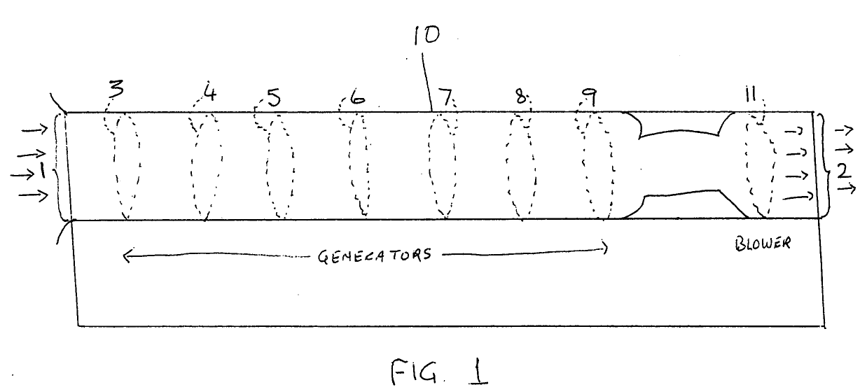

The Sole FIG. 1 is a functional block diagram of ‘Vacuum Powered Generators’ of this invention.

### DETAILED DESCRIPTION OF THE INVENTION

### Overview of Vacuum Power Generation

The present invention is comprised of a wind tunnel (10) for generating electrical energy by producing a draft to power the propellers/turbines (3-9) arrangement disposed within the wind tunnel. The said wind tunnel contains an inlet (1) and outlet (2) with one way valves at both ends. The inlet valve only allows air to come in, and the outlet valve only lets air out, thereby confining the wind draft to move from the inlet end to the outlet end.

Inside the wind tunnel are mounted, at a selected distance from one another, a plurality of wind driven propellers. Electric generators are operatively connected to said propellers by a mechanical transmission means and a gearing to convert mechanical energy of said wind driven turbines into electrical energy.

A blower (11) is mounted in the wind tunnel just inside the outlet end. Said blower is powered by an outside electrical energy source. In case of moving vehicles the said outside electrical source is a fully charged battery. In case of nonmoving entities the said outside electrical source can be any electrical power source.

When the blower is switched on it causes air from the wind tunnel to exit out at said outlet end, thus causing a vacuum in the wind tunnel. Atmospheric air rushes in from the inlet end to fill said vacuum. A wind draft is created. Said propellers placed between the two ends of the wind tunnel catch the draft and thus generate electricity. Said generators can be aligned serially and/or parallel depending on the amount of voltage needed.

In conclusion there are many universal laws that have been harnessed. Pullies, fulcrums, levers and hydraulic pressure have been put to good use. However these are laws that have not been harnessed fully. With the complex system of levers, pulleys, fulcrums and hydraulic pressure this inventor can produce a water powered generator. One universal law that has hardly been exploited is that nature abhors a vacuum; wherever an area of low pressure is present, atmospheric pressure will make it even by bringing in air from the surrounding high pressure area. This applicant is proposing a vacuum powered generator.

By producing a vacuum in one particular area, letting air rush in through a controlled path and by placing propellers in this path, thusly producing a wind draft that generates electricity. One may safely say that vacuum power is the fulcrum of wind power.

Although the description above contains many specifications, these should not be construed as limiting the scope of the invention but as merely providing an illustration of one of the preferred embodiments of this invention.

1) A system for recovery of electrical energy from a combination of vacuum power and man made energy source, said system comprising:
a) a pipe (or wind tunnel) with an inlet and an outlet;
b) a vacuum portion at outlet end of said pipe created for airflow;
c) a plurality of wind propelled turbines installed in said pipe;
d) a one way valve installed at inlet end to let in air into said pipe;
e) a one way valve installed at outlet end to let air out of said pipe;
f) conveying portion in between the inlet and outlet of the pipe;
g) wherein vacuum is created by outside power driven blower placed at the outlet end of pipe;
h) electric generators are operatively connected to said wind driven turbines;
i) said generators connected to the said turbines by mechanical transmission means, and a gearing;
j) as said vacuum is created at the outlet end of the pipe wind draft is created that rushes in from the inlet causing the draft to generate electricity by driving the turbines;
k) an apparatus as described in claim, one where said pipe is made of metal;

2) An apparatus as described in claim 1, where said pipe is made of plastic.

3) An apparatus as described in claim 1, where said pipe is made of masonry.

4) An apparatus as described in claim 1, where said pipe is made of metal.

5) An apparatus as described in claim 1, where said wind pipe can be shaped like a slinky.

6) An apparatus as described in claim 1, where said pipe can be shaped like a straight line.

7) An apparatus as described in claim 1, where said pipe can be zigzag shaped.

8) An apparatus as described in claim 1, where said pipe can be enclosed in its own supply of air for space or submarine travel.

9) An apparatus as described in claim 1, where said pipe can be shaped according to the contours of the premises where it is used.

10) An apparatus as described in claim 1, where the system functions only by the power of vacuum pressure.

11) An apparatus as described in claim 1, where the system can be portable.

12) An apparatus as described in claim 1, where the system can be installed in moving vehicles.
